(19) United States
(12) Patent Application Publication
(10) Pub. No.: US 2025/0194655 A1
(43) Pub. Date: Jun. 19, 2025

(54) Dissolvable Infant Formula Pod Device

(71) Applicant: Stephanie Jordan, Kihei, HI (US)

(72) Inventor: Stephanie Jordan, Kihei, HI (US)

(21) Appl. No.: 18/596,140

(22) Filed: Mar. 5, 2024

Related U.S. Application Data
(60) Provisional application No. 63/609,487, filed on Dec. 13, 2023.

(51) Int. Cl. A23L 33/00; A23L 29/30

(52) U.S. Cl. CPC A23L 33/40; A23L 29/30

(57) ABSTRACT

A dissolvable infant formula pod device is provided. The device is comprised of a body comprised of an infant formula powder enclosed in a water-soluble outer layer. As a result, the body can be dropped into a pre-measured amount of water, wherein the outer layer dissolves and releases the powder into the water to create a bottle formula that can be fed to an infant.

### CROSS-REFERENCE TO RELATED APPLICATION

The present application claims priority to, and the benefit of, U.S. Provisional Application No. 63/609,487, which was filed on Dec. 13, 2023, and is incorporated herein by reference in its entirety.

### FIELD OF THE INVENTION

The present invention relates generally to the field of infant formula. More specifically, the present invention relates to a dissolvable infant formula pod device that provides powdered bottle formula enclosed in a water-soluble outer layer. Accordingly, the present disclosure makes specific reference thereto. Nonetheless, it is to be appreciated that aspects of the present invention are also equally applicable to other like applications, devices, and methods of manufacture.

### BACKGROUND

Infant formula is typically sold in powdered form. This form, while convenient for storage and shelf life, presents several practical challenges during daily use. More specifically, formula powder can spill easily, leading to frequent clean-ups on countertops, tables, and even clothing. Such spills are not only inconvenient but can also waste the product.

Further, formula powder scoopers are prone to getting buried under the powder in the storage containers. This forces users to sift through the formula to locate the scooper. This process is not only frustrating but also raises hygiene concerns if a caregiver's hands are wet, the powder sticks to the skin, which can be uncomfortable and also potentially contaminate the remaining formula, leading to spoilage.

Further, the act of preparing an infant bottle using powdered formula and a scoop can be surprisingly time-consuming. The time spent measuring and mixing the formula can lead to delays in feeding, which can result in an increasingly upset and hungry baby. This scenario adds stress to what could be a more streamlined and efficient process.

Additionally, for new parents or caregivers who are not yet accustomed to the quirks of handling powdered formula, the learning curve can be steep. Missteps in preparation can lead to incorrect formula concentration, which is critical for the baby's health. The process of correctly measuring and mixing, ensuring no lumps remain, and achieving the right temperature adds several layers of complexity to what is a frequent and essential task.

Therefore, there exists a long-felt need in the art for an improved infant formula powder. There also exists a long-felt need in the art for a dissolvable infant formula pod device. Further, there exists a long-felt need in the art for a dissolvable infant formula pod device that simplifies the bottle-making process. In addition, there exists a long-felt need in the art for a dissolvable infant formula pod device that prevents the spilling of formula powder.

The subject matter disclosed and claimed herein, in one embodiment thereof, comprises a dissolvable infant formula pod device. The device is comprised of a body comprised of an infant formula powder enclosed in a water-soluble outer layer. As a result, the body can be dropped into a pre-measured amount of water, wherein the outer layer dissolves and releases the powder into the water to create a bottle formula that can be fed to an infant.

In this manner, the dissolvable infant formula pod device of the present invention accomplishes all the foregoing objectives and provides an improved infant formula powder. Due to the self-contained body, the device simplifies the bottle-making process and prevents the spilling of formula powder. Therefore, the device eliminates many of the known pitfalls of making bottles with formula powder.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a dissolvable infant formula pod device comprised of a body with a water-soluble outer layer that encloses an infant formula powder. As a result, the body can be placed in water, wherein the outer layer dissolves and the powder mixes with the formula to create an infant bottle-feeding mixture.

The outer layer of the body is preferably made from a water-soluble material. This includes, but is not limited to, gelatin, Hypromellose, agar-agar, polysaccharides, or any other edible, natural, water-soluble, material. In this manner, the outer layer dissolves in water. The outer layer surrounds a powder within the body. The powder may be any type of infant powder formula such as, but not limited to, a cow's milk-based formula powder, a soy-based formula powder, a lactose-free formula powder, a hydrolyzed protein formula powder, a metabolic formula powder, a hypoallergenic formula powder, an organic formula powder, etc. The size of the body may correlate to the amount of powder within the body. The amount of powder is preferably enough to make an infant feeding formula when added to 2-4 ounces of water.

The present invention is also comprised of a method of using the device. First, a device is provided comprised of a body comprised of a water-soluble outer layer that encloses a formula powder. Then, the body can be placed in an amount of water (preferably, but not limited to, 2-4 fluid ounces of water). Once this occurs, the outer layer dissolves and the powder is released into the water. Then, a user can mix the water and powder mixture. Finally, a user can feed the mixture to an infant.

Accordingly, the dissolvable infant formula pod device of the present invention is particularly advantageous as it provides an improved infant formula powder. Due to the self-contained body, the device simplifies the bottle-making process and prevents the spilling of formula powder. In this manner, the dissolvable infant formula pod device overcomes the limitations of existing powder formulas and bottle-making methods known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side cross-sectional view of one potential embodiment of a dissolvable infant formula pod device of the present invention in accordance with the disclosed architecture;

FIG. 2 illustrates a perspective view of one potential embodiment of a dissolvable infant formula pod device of the present invention while in packaging in accordance with the disclosed architecture; and

FIG. 3 illustrates a flowchart of a method of using one potential embodiment of a dissolvable infant formula pod device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved infant formula powder. There also exists a long-felt need in the art for a dissolvable infant formula pod device. Further, there exists a long-felt need in the art for a dissolvable infant formula pod device that simplifies the bottle-making process. In addition, there exists a long-felt need in the art for a dissolvable infant formula pod device that prevents the spilling of formula powder.

The present invention, in one exemplary embodiment, is comprised of a dissolvable infant formula pod device. The device is comprised of a body with a water-soluble outer layer that encloses an infant formula powder. During use, the body can be placed in water, wherein the outer layer dissolves and the powder mixes with the formula to create an infant bottle-feeding mixture.

The outer layer of the body is preferably made from a water-soluble material such as, but not limited to, gelatin, Hypromellose, agar-agar, polysaccharides, or any other edible, natural, water-soluble, material. In this manner, the outer layer dissolves in water. The outer layer surrounds a powder within the body, wherein the powder may be any type of infant powder formula such as, but not limited to, a cow's milk-based formula powder, a soy-based formula powder, a lactose-free formula powder, a hydrolyzed protein formula powder, a metabolic formula powder, a hypoallergenic formula powder, an organic formula powder, etc. The size of the body may correlate to the amount of powder within the body. The amount of powder is preferably enough to make an infant feeding formula when added to 2-4 ounces of water.

The present invention is also comprised of a method of using the device. First, a device is provided comprised of a body comprised of a water-soluble outer layer that encloses a formula powder. Then, the body can be placed in an amount of water (preferably, but not limited to, 2-4 fluid ounces of water). Once this occurs, the outer layer dissolves and the powder is released into the water. Then, a user can mix the water and powder mixture. Finally, a user can feed the mixture to an infant.

Accordingly, the dissolvable infant formula pod device of the present invention is particularly advantageous as it provides an improved infant formula powder. Due to the self-contained body, the device simplifies the bottle-making process and prevents the spilling of formula powder. In this manner, the dissolvable infant formula pod device overcomes the limitations of existing powder formulas and bottle-making methods known in the art.

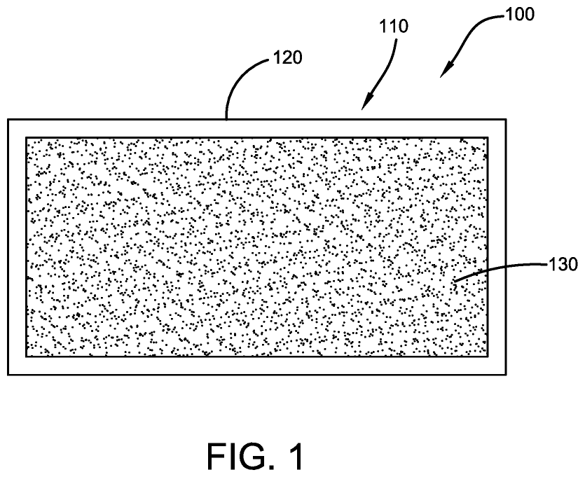

Referring initially to the drawings, FIG. 1 illustrates a side cross-sectional view of one potential embodiment of a dissolvable infant formula pod device 100 of the present invention in accordance with the disclosed architecture. The device 100 is comprised of a body 110 that is comprised of a water-soluble outer layer 120 that encloses an infant formula powder 130. As a result, the body 110 can be placed in water, wherein the outer layer 120 dissolves and the powder 130 mixes with the formula to create an infant bottle-feeding mixture.

The body 110 may be any shape and size in different embodiments. The body 110 may also be any color. The outer layer 120 of the body 110 is preferably made from a water-soluble material. This includes, but is not limited to, gelatin, Hypromellose, agar-agar, polysaccharides, protein-whey, potato starch, or any other edible, natural, water-soluble, material. In this manner, the outer layer 120 dissolves in water.

The outer layer 120 surrounds a powder 130 within the body 110. The powder 130 may be any type of infant powder formula such as, but not limited to, a cow's milk-based formula powder, a soy-based formula powder, a lactose-free formula powder, a hydrolyzed protein formula powder, a metabolic formula powder, a hypoallergenic formula powder, an organic formula powder, etc.

The size of the body 110 may correlate to the amount of powder 130 within the body 110. The amount of powder 130 may be any amount. However, the amount of powder 130 is preferably enough to powder to make an infant feeding formula when added to 2-4 ounces of water. However, the amount of powder 130 may vary such that it is enough to make an infant feeding formula when added to the added amount of water.

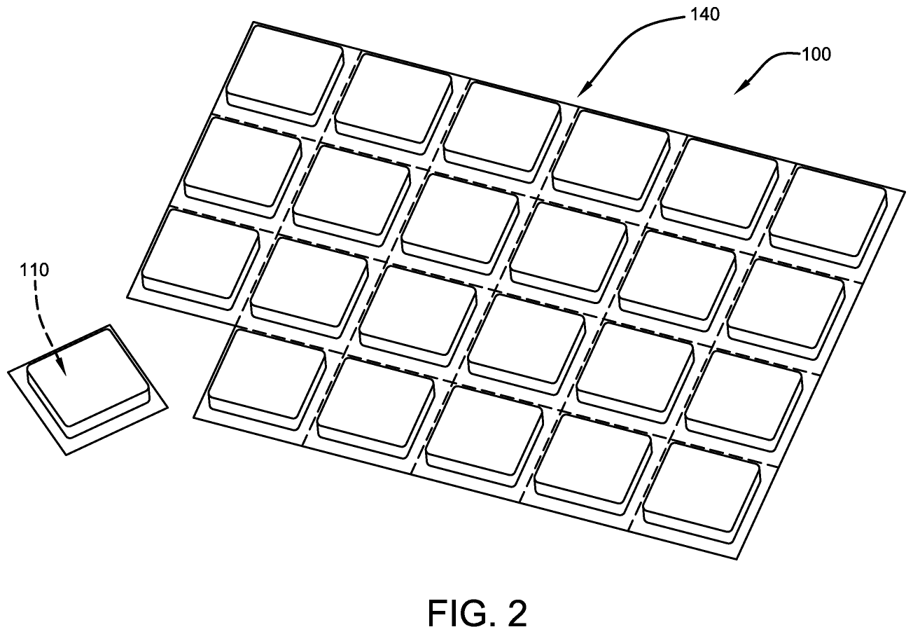

In one embodiment, the body 110 is individually sealed in packaging 140 of any type, as seen in FIG. 2. In one embodiment, a plurality of bodies 110 are packaged together in a packaging, wherein each body 110 is separated by a tear-able perforation 142. The packaging 140 may be any package type known in the art such as, but not limited to, a box, a bottle, a jar, a film, etc.

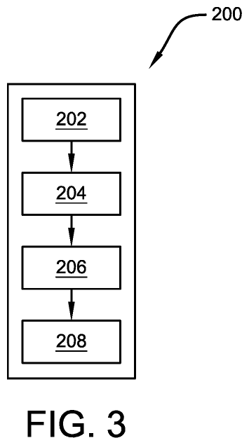

The present invention is also comprised of a method of using 200 the device 100, as seen in FIG. 3. First, a device 100 is provided comprised of a body 110 comprised of a water-soluble outer layer 120 that encloses a formula powder 130 [Step 202]. Then, the body 110 can be placed in an amount of water (preferably, but not limited to, 2-4 fluid ounces of water) [Step 204]. Once this occurs, the outer layer 120 dissolves and the powder 130 is released into the water. Then, a user can mix the water and powder 130 mixture [Step 206]. Finally, a user can feed the mixture to an infant [Step 208].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “dissolvable infant formula pod device” and “device” are interchangeable and refer to the dissolvable infant formula pod device 100 of the present invention.

Notwithstanding the foregoing, the dissolvable infant formula pod device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the dissolvable infant formula pod device 100 as shown in the FIGS. are for illustrative purposes only, and that many other sizes and shapes of the dissolvable infant formula pod device 100 are well within the scope of the present disclosure. Although the dimensions of the dissolvable infant formula pod device 100 are important design parameters for user convenience, the dissolvable infant formula pod device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A dissolvable infant formula pod device comprising:
a body comprised of a water-soluble outer layer that encases a powder.

2. The dissolvable infant formula pod device of claim 1, wherein the outer layer is comprised of an edible material.

3. The dissolvable infant formula pod device of claim 2, wherein the edible material is comprised of a gelatin, a Hypromellose, an agar-agar, or a polysaccharide.

4. The dissolvable infant formula pod device of claim 1, wherein the powder is comprised of an infant formula powder.

5. The dissolvable infant formula pod device of claim 4, wherein the infant formula powder is comprised of a cow's milk-based formula powder, a soy-based formula powder, a lactose-free formula powder, a hydrolyzed protein formula powder, a metabolic formula powder, a hypoallergenic formula powder, or an organic formula powder.

6. A dissolvable infant formula pod device comprising:
a body comprised of a water-soluble outer layer that encases a formula powder; and
a packaging.

7. The dissolvable infant formula pod device of claim 6, wherein the outer layer is comprised of an edible material.

8. The dissolvable infant formula pod device of claim 7, wherein the edible material is comprised of a gelatin, a Hypromellose, an agar-agar, or a polysaccharide.

9. The dissolvable infant formula pod device of claim 6, wherein the powder is comprised of an infant formula powder.

10. The dissolvable infant formula pod device of claim 9, wherein the infant formula powder is comprised of a cow's milk-based formula powder, a soy-based formula powder, a lactose-free formula powder, a hydrolyzed protein formula powder, a metabolic formula powder, a hypoallergenic formula powder, or an organic formula powder.

11. The dissolvable infant formula pod device of claim 6, wherein the packaging is comprised of a box.

12. The dissolvable infant formula pod device of claim 6, wherein the packaging is comprised of a bottle.

13. The dissolvable infant formula pod device of claim 6, wherein the packaging is comprised of a jar.

14. The dissolvable infant formula pod device of claim 6, wherein the packaging is comprised of a film.

15. The dissolvable infant formula pod device of claim 6, wherein the packaging is comprised of a perforation.

16. A method of using a dissolvable infant formula pod device, the method comprising the following steps:
providing a dissolvable infant formula pod device comprised of a body comprised of a water-soluble outer layer that encloses a formula powder; and
placing the body in an amount of water such that the water-soluble outer layer dissolves;
mixing the water and the powder.

17. The method of using the dissolvable infant formula pod device of claim 16, wherein the outer layer is comprised of an edible material.

18. The method of using the dissolvable infant formula pod device of claim 17, wherein the edible material is comprised of a gelatin, a Hypromellose, an agar-agar, or a polysaccharide.

19. The method of using the dissolvable infant formula pod device of claim 16, wherein the powder is comprised of an infant formula powder.

20. The method of using the dissolvable infant formula pod device of claim 19, wherein the infant formula powder is comprised of a cow's milk-based formula powder, a soy-based formula powder, a lactose-free formula powder, a hydrolyzed protein formula powder, a metabolic formula powder, a hypoallergenic formula powder, or an organic formula powder.
